(19) United States
(12) Patent Application Publication
(10) Pub. No.: US 2022/0067730 A1
(43) Pub. Date: Mar. 3, 2022

(54) DATA PROCESSING METHOD AND DEVICE AND COMPUTER-READABLE STORAGE MEDIUM

(71) Applicant: TENCENT TECHNOLOGY (SHENZHEN) COMPANY LIMITED, Shenzhen (CN)

(72) Inventors: Dongyan WANG, Shenzhen (CN); Maocai LI, Shenzhen (CN); Zongyou WANG, Shenzhen (CN); Haitao TU, Shenzhen (CN); Qucheng LIU, Shenzhen (CN); Bo LI, Shenzhen (CN)

(21) Appl. No.: 17/521,478

(22) Filed: Nov. 8, 2021

Related U.S. Application Data
(63) Continuation of application No. PCT/CN2020/117378, filed on Sep. 24, 2020.

(30) Foreign Application Priority Data
Oct. 28, 2019 (CN) 201911033903.9

(51) Int. Cl. G06Q 20/40; G06F 16/25; G06F 21/60; G06Q 20/38

(52) U.S. Cl. CPC G06Q 20/401; G06F 16/258; G06Q 2220/00; G06Q 20/389; G06F 21/602

(57) ABSTRACT

A data processing method is provided for a processing node. The method includes: transmitting a data acquisition request to a data node to cause the data node performing a preprocessing operation on source data according to the data acquisition request, generating target data, and recording operation information of the preprocessing operation in an operation ledger; receiving the target data and the operation ledger; auditing the target data by using the operation ledger in an audit, to determine whether the preprocessing operation is a valid operation; and adding the target data to an aggregated data set when the target data passes the audit, the aggregated data set comprising a plurality of pieces of data that pass the audit, the plurality of pieces of data that pass the audit being provided to a business node, so that the business node provides a business service to a user.

### RELATED APPLICATIONS

This application is a continuation application of PCT Patent Application No. PCT/CN2020/117378, filed on Sep. 24, 2020, which claims priority to Chinese Patent Application No. 201911033903.9, filed with the Chinese Patent Office on Oct. 28, 2019, and entitled “DATA PROCESSING METHOD AND DEVICE”, the entire contents of both of which are incorporated herein by reference.

### FIELD OF TECHNOLOGY

This application relates to the field of Internet technologies and data processing technologies and, in particular, to a data processing method and device and a computer-readable storage medium.

### BACKGROUND

A data processing process is involved in many Internet application scenarios (such as an insurance purchasing scenario, a bank loan scenario, and an advertisement delivery scenario). Data to be processed usually includes some private data, such as deposit data (for example, a specific deposit amount) of a user and some private social data (for example, a personal address and some private pictures) of the user. Therefore, a protection mechanism needs to be set for the data processing process to protect the private data from leakage in the processing process.

A protection mechanism is a beforehand code review mechanism. Specifically, before a data processing process is performed, all code programs used in the data processing process are reviewed manually or by using a dedicated tool to determine whether the code programs are reliable. If the code programs are reliable, it is allowed to use the code programs to perform the data processing process. However, such processes are often insufficient and/or prone to errors. The disclosed methods and systems are directed to solve one or more problems set forth above and other problems.

### SUMMARY

Embodiments of the present disclosure provide a data processing method, apparatus, and device and a computer-readable storage medium, so that the security of a data processing process can be improved.

An embodiment of the present disclosure provides a data processing method is provided for a processing node. The method includes: transmitting a data acquisition request to a data node to cause the data node performing a preprocessing operation on source data according to the data acquisition request, generating target data, and recording operation information of the preprocessing operation in an operation ledger; receiving the target data and the operation ledger; auditing the target data by using the operation ledger in an audit, to determine whether the preprocessing operation is a valid operation; and adding the target data to an aggregated data set when the target data passes the audit, the aggregated data set comprising a plurality of pieces of data that pass the audit, the plurality of pieces of data that pass the audit being provided to a business node, so that the business node provides a business service to a user.

Another embodiment of the present disclosure provides a data processing method for a data node. The method includes receiving a data acquisition request transmitted by a processing node; performing a preprocessing operation on source data according to the data acquisition request, to generate target data; recording operation information of the preprocessing operation through an operation ledger; and returning the target data and the operation ledger to the processing node, to cause the processing node to audit the target data by using the operation ledger in an audit, to determine whether the preprocessing operation recorded in the operation ledger is a valid operation, and add the target data to an aggregated data set when the target data passes the audit, the aggregated data set comprising a plurality of pieces of data that pass the audit, the plurality of pieces of data that pass the audit being provided to a business node, so that the business node provides a business service to a user.

Another embodiment of the present disclosure provides a data processing system. The data processing system includes at least a processing node and a data node. The processing node comprises: a request transmit unit, a ledger receiving unit, an audit unit, and a processing unit. The request transmit unit is configured to transmit a data acquisition request to the data node, to cause the data node performing a preprocessing operation on source data according to the data acquisition request, generating target data, and recording operation information of the preprocessing operation in an operation ledger. The ledger receiving unit is configured to receive the target data and the operation ledger returned by the data node. The audit unit is configured to audit the target data by using the operation ledger in an audit, to determine whether the preprocessing operation recorded in the operation ledger is a valid operation. The processing unit is configured to add the target data to an aggregated data set when the target data passes the audit, the aggregated data set comprising a plurality of pieces of data that pass the audit, the plurality of pieces of data that pass the audit being provided to a business node, so that the business node provides a business service to a user.

Other aspects of the present disclosure can be understood by those skilled in the art in light of the description, the claims, and the drawings of the present disclosure.

### BRIEF DESCRIPTION OF THE DRAWINGS

To describe the embodiments of the present disclosure more clearly, the following briefly introduces the accompanying drawings for describing the embodiments. Apparently, the accompanying drawings in the following description show only some embodiments of the present disclosure, and a person of ordinary skill in the art may still derive other drawings from these accompanying drawings without creative efforts.

FIG. 1 is a diagram of a basic architecture of a blockchain according to certain embodiments of the present disclosure.

FIG. 2 is a schematic structural diagram of a blockchain according to certain embodiments of the present disclosure.

FIG. 3 is a schematic architectural diagram of a blockchain network according to certain embodiments of the present disclosure.

FIG. 4 is a schematic architectural diagram of a data processing system according to certain embodiments of the present disclosure.

FIG. 5A to FIG. 5C are flowcharts of a data processing method according to certain embodiments of the present disclosure.

FIG. 6 is a schematic diagram of storage of an operation ledger according to certain embodiments of the present disclosure.

FIG. 7A is a schematic diagram of an audit smart contract according to certain embodiments of the present disclosure.

FIG. 7B is a schematic diagram of another audit smart contract according to certain embodiments of the present disclosure.

FIG. 8 is a flowchart of a data processing method according to certain embodiments of the present disclosure.

FIG. 9 is a schematic diagram of data flow directions of a data processing method according to certain embodiments of the present disclosure.

FIG. 10 is a schematic structural diagram of a data processing apparatus according to certain embodiments of the present disclosure.

FIG. 11 is a schematic structural diagram of another data processing apparatus according to certain embodiments of the present disclosure.

FIG. 12 is a schematic structural diagram of a data processing device according to certain embodiments of the present disclosure.

### DETAILED DESCRIPTION

The technical solutions in embodiments of the present disclosure are described in the following with reference to the accompanying drawings. Apparently, the described embodiments are merely some rather than all of the embodiments of the present disclosure. Other embodiments obtained by a person of ordinary skill in the art based on the disclosed embodiments of the present disclosure without making creative efforts shall fall within the protection scope of the present disclosure.

To protect private data from leakage in a processing process, a beforehand code review mechanism may be used. Specifically, before a data processing process is performed, all code programs used in the data processing process are reviewed manually or by using a dedicated tool to determine whether the code programs are reliable. If the code programs are reliable, it is allowed to use the code programs to perform the data processing process. However, such a beforehand code review mechanism protects data only to a limited extent, and it is difficult to predict the security of a code program in an actual execution process.

In addition, a calculation model on a business side usually uses data from a plurality of aspects, that is, data is aggregated for calculation. The calculation model on the business side also requires protection. Therefore, it is usually impossible to completely open all codes.

In the embodiments of the present disclosure, target data provided by a data node is securely and credibly audited by using an operation ledger. The target data is data generated by performing a preprocessing operation on source data. A process of the audit can ensure that the preprocessing operation is performed according to a processing rule that is jointly recognized by an owner (for example, a data node) of source data and a processing node, to ensure that the target data can be successfully added to an aggregated data set for use in a subsequent process. In addition, private data in the source data is protected from leakage. It can also be ensured that all data in the aggregated data set is reliable data, to ensure the security of a subsequent process in which the aggregated data set is used, thereby improving the security of a data processing process.

A blockchain is used in the embodiments of the present disclosure. The blockchain is a set of decentralized basic architecture with distributed storage, and is specifically a data structure that is formed by data blocks in time order in a manner similar to a linked list. The blockchain can securely store chronological data that can be verified in a system, and uses cryptology to ensure that data is tamper-proof and unforgeable.

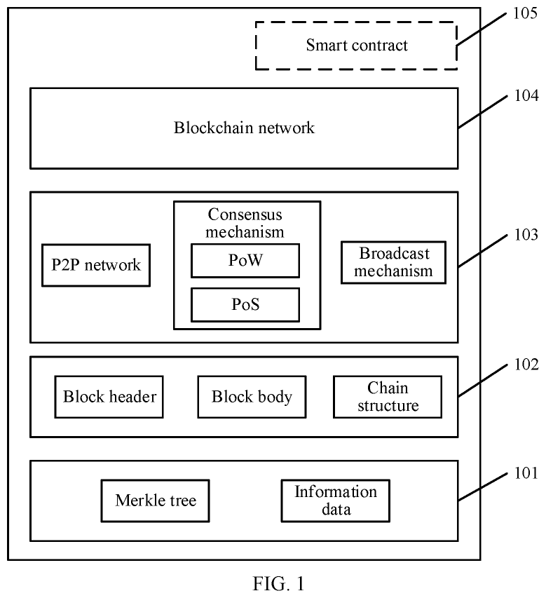

FIG. 1 is a diagram of a basic architecture of a blockchain according to certain embodiments of the present disclosure. As shown in FIG. 1, the basic architecture of the blockchain mainly includes a total of five layer structures 101 to 105 from bottom to top.

(1) Information data and a Merkle tree are located in the bottom layer 101. The information data herein is original data that is requested to be published to a blockchain network but has not formed a block, and may be, for example, loan data or transaction data. The original data requires further processing (for example, verification by nodes in the blockchain network and hash operation) before the original data can be written into a block. The Merkle tree is an important part of a blockchain technology. The blockchain does not directly save plaintext original data. The original data requires the hash operation and storage in hash values. The Merkle tree is used for organizing hash values according to a binary tree structure, the hash values being formed after a hash operation is performed on a plurality of pieces of original data, and saving the hash values in a block body of a block.

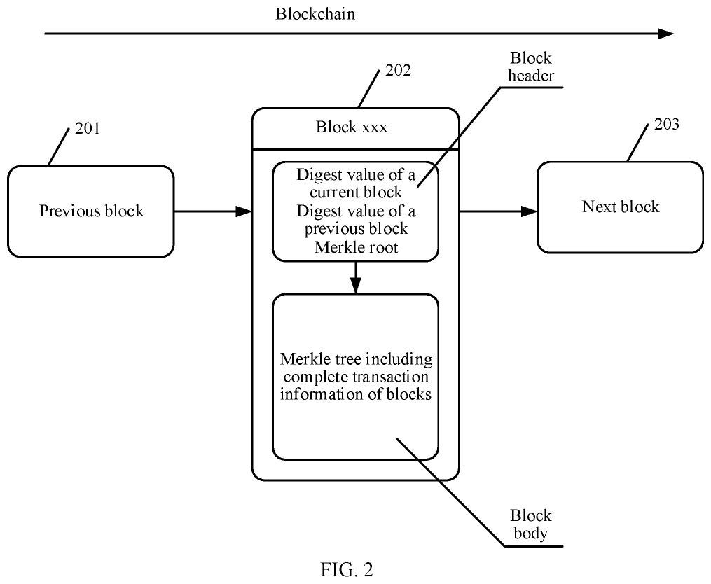

(2) A block is located in the layer 102. The block is a data block. The information data at the bottom layer 101 is further processed and written into a block in the layer 102. A plurality of blocks are sequentially connected to form a chain structure, that is, to form a blockchain. FIG. 2 is a schematic structural diagram of a blockchain according to certain embodiments of the present disclosure. As shown in FIG. 2, a block 201, a block 202, and a block 203 are sequentially connected to form a chain structure. The block 202 includes a block header and a block body. The block header includes a digest value of the previous block 201, a digest value of the current block 202, and a Merkle root of the current block. The block body includes complete data of the current block 202, and organizes the data together in the form of a Merkle tree.

(3) Protocols and mechanisms that the blockchain follows are located in the layer 103. These protocols may include a peer-to-peer (P2P) network protocol. The mechanisms may include, but not limited to broadcast mechanisms and consensus mechanisms (including core mechanisms such as a proof of work (PoW) mechanism and a proof of stake (PoS) mechanism).

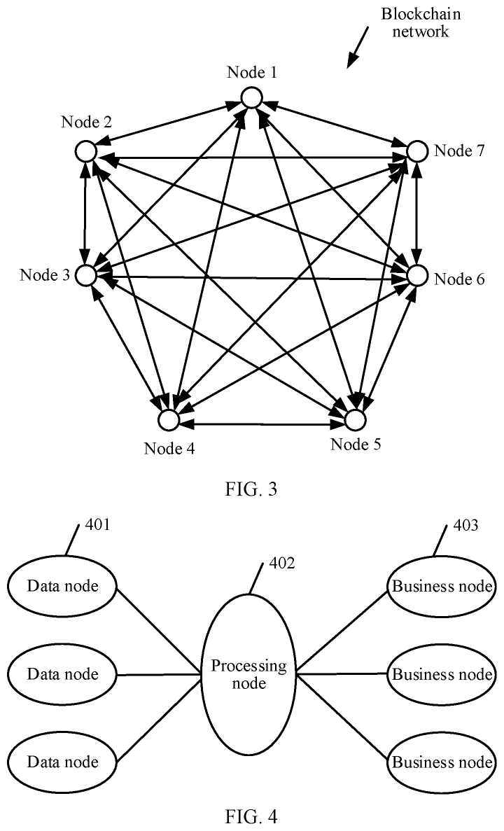

(4) The blockchain network is located in the layer 104. The blockchain network is formed by a plurality of nodes. Devices that may be used as nodes may include, but not limited to: a personal computer (PC), a server, a mining machine designed for bitcoin mining, a smart phone, a tablet computer, and a mobile computer. FIG. 3 is a schematic architectural diagram of a blockchain network according to certain embodiments of the present disclosure. Seven nodes are used as an example in the figure for description. The nodes in the blockchain network form a network in a P2P manner. The nodes communicate with each other according to P2P protocols. The nodes jointly follow a broadcast mechanism and a consensus mechanism (including core mechanisms such as a PoW mechanism and a PoS mechanism), to jointly ensure that data on the blockchain is tamper-proof and unforgeable and the blockchain is decentralized and trustless.

(5) The smart contract is located in the upper layer 105. The smart contract is a group of scenario-response programmed rules and logic, and is a decentralized program code that is deployed on the blockchain and has sharable information. Participants signing a contract reach an agreement on content of the contract, and the content is deployed on the blockchain in the form of a smart contract, so that the signatories can be automatically represented to execute the contract without the need of any central organization.

Because the blockchain has decentralized and distributed storage and tamper-proof and unforgeable data, an increasingly large number of business activities (for example, a loan activity, and a financial transaction activity) are performed based on a blockchain technology, to use the features of the blockchain to ensure the fairness and publicness of the business activities.

Aggregation calculation is used in the embodiments of the present disclosure. The so-called aggregation calculation is a calculation process of aggregating a plurality of pieces of data into one piece of data. In data processing processes of many Internet application scenarios, an aggregation calculation process is usually involved. For example, in an insurance purchasing scenario, a due insurance premium of a user is determined based on basic insurance data of the user. The basic insurance data of the user is obtained through aggregation calculation of a plurality of pieces of historical behavior data of the user. The plurality of pieces of historical behavior data herein may be historical diagnosis and treatment data of the user in a plurality of medical institutions within a set historical period of time, and the like. In another example, in a bank loan scenario, a loan amount allowed for a user is assessed based on loan qualification evaluation data of the user. The loan qualification evaluation data of the user is obtained through aggregation calculation of a plurality pieces of historical asset data of the user. The plurality pieces of historical asset data herein may be historical deposit data or historical loan data of the user in a plurality of banks. In another example, in an advertisement delivery scenario, the types of advertisements to be delivered to a user are determined based on interest data of the user. The interest data of the user is obtained through aggregation calculation of a plurality of pieces of historical social data of the user. The plurality of pieces of historical social data herein may be historical social data of the user in a plurality of social platforms.

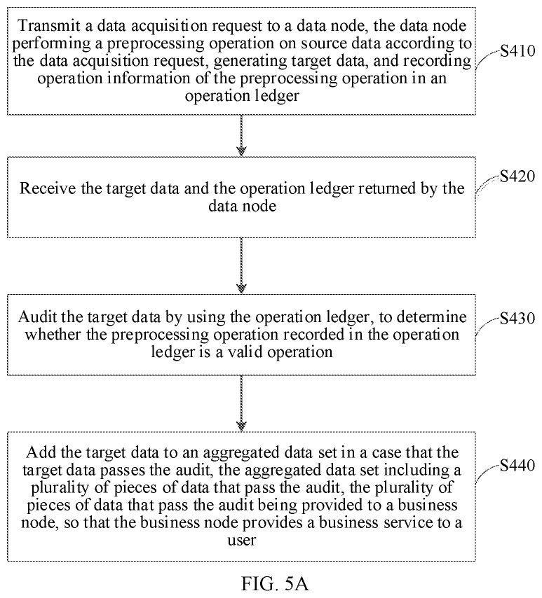

FIG. 4 is a schematic architectural diagram of a typical data processing system according to certain embodiments of the present disclosure. As shown in FIG. 4, the data processing system includes a processing node 402, a plurality of data nodes 401 connected to the processing node 402, and a business node 403 connected to the processing node.

The data node 401 is a device that can provide target data suitable for use by a data processing process (for example, an aggregation calculation process). In a specific implementation, the data node may include, but not limited to: device such as a PC, a personal digital assistant (PDA, a tablet computer), a mobile phone, a smart wearable device, and a server. In some implementations, the data node 401 may be an owner of source data. The data node 401 has a preprocessing capability and can perform a preprocessing operation on the source data to obtain target data and provide the target data to an aggregation calculation process. In some other implementations, the data node 401 may be a device independent of the owner of the source data, and the data node 401 can obtain the source data from the owner of the source data and perform a preprocessing operation on the source data to obtain the target data. The owner of the source data herein may be a device storing the source data. For example, the source data is historical diagnosis and treatment data of a user. The owner of the source data may be a service device that belongs to medical institutions that the user has visited and is configured to store the historical diagnosis and treatment data of the user. In another example, the source data is historical deposit data or historical loan data of a user. In this case, the owner of the source data may be a service device that belongs to banks that the user has visited and is configured to store the historical deposit data or the historical loan data of the user. In another example, the source data is historical social data of a user. The owner of the source data may be a service device that belongs to social platform systems that the user has visited and is configured to store the historical social data of the user.

The business node 403 is a request device that initiates a data processing request to request to obtain aggregated response data. The business node 403 may include devices such as a PC, a PDA (a tablet computer), a mobile phone, a smart wearable device, and a server. For example, in an insurance purchasing scenario, based on a requirement of a determined due insurance premium of a user, an employee of an insurance company uses a terminal device to initiate a data processing request to the processing node, to request the processing node 402 to perform aggregation calculation on historical diagnosis and treatment data of the user in a plurality of medical institutions within a set historical period of time to obtain basic insurance data of the user. In this example, the terminal device used by the employee of the insurance company is the business node 403. In another example, in a bank loan scenario, based on a requirement of an assessed loan amount allowed for a user, a bank worker uses a terminal device to initiate a data processing request to request the processing node 402 to perform aggregation calculation on a plurality pieces of historical asset data of the user to obtain loan qualification evaluation data of the user. In this example, the terminal device used by the bank worker is the business node 403. In another example, in an advertisement delivery scenario, based on a requirement of determining types of advertisements to be delivered to a user, an advertiser uses a server of the advertiser to initiate a data processing request, to request to perform aggregation calculation on a plurality of pieces of historical social data of the user to obtain interest data of the user. In this case, the server used by the advertiser is the business node 403.

The processing node 402 may be configured to perform a data processing (for example, smart calculation) process. The business node 402 may include devices such as a PC, a PDA (tablet computer), a mobile phone, a smart wearable device, and a server. Specifically, the processing node 402 may receive the data processing request of the business node 403, determine a plurality of related data nodes 401 according to the data processing request, and trigger the plurality of data nodes 401 to provide target data used for aggregation calculation; then perform aggregation calculation on these target data to obtain response data for a requirement of the business node; and finally return the response data to the business node 403. For example, in an insurance purchasing scenario, the processing node 402 receives a data processing request transmitted by the business node 403 (a terminal device used by an employee of an insurance company), analyzes the data processing request to determine service devices of a plurality of medical institutions as data nodes, triggers these data nodes 401 to provide historical diagnosis and treatment data of a user, performs aggregation calculation on these historical diagnosis and treatment data to obtain basic insurance data of the user, and returns the basic insurance data to the business node 403.

In another example, in a bank loan scenario, the processing node 402 receives a data processing request transmitted by the business node 403 (a terminal device used by a bank worker), analyzes the data processing request to determine service devices of a plurality of banks as data nodes 401, triggers these data nodes 401 to provide historical deposit data or historical loan data of a user, performs aggregation calculation on these historical deposit data or historical loan data to obtain loan qualification evaluation data of the user, and returns the loan qualification evaluation data to the business node 403.

In another example, in an advertisement delivery scenario, the processing node 401 receives a data processing request transmitted by the business node 403 (a server used by an advertiser), analyzes the data processing request to determine service devices of a plurality of social platforms as data nodes 401, triggers these data nodes 401 to provide historical social data of a user, performs aggregation calculation on these historical social data to obtain interest data of the user, and returns the interest data to the business node 403. The processing node 402 may be an independent device or may be a combination of a plurality of devices. Specifically, the data processing process performed by the processing node 402 may be divided into a plurality of subprocesses. For example, based on the foregoing description, the data processing process performed by the processing node 402 may include an aggregation calculation process and a reception and response process for a data processing request transmitted by the business node. In this case, when one device has both an aggregation calculation capability and a communication capability between business nodes, this device may be used as the processing node 402 to independently perform a data processing procedure. Certainly, when a device has only an aggregation calculation capability and another device has a communication capability between business nodes, a combination of the two devices may be used as one processing node 402. The two devices coordinate to perform a data processing procedure. For example, the device having the communication capability receives a data processing request transmitted by a business node, and transmits the data processing request to the device having the aggregation calculation capability, to trigger the device having the aggregation calculation capability to perform aggregation calculation. After completing the aggregation calculation to obtain response data, the device having the aggregation calculation capability transmits the response data back to the device having the communication capability. The device having the communication capability returns the response data to the business node.

In a data processing process, target data required for aggregation calculation comes from source data. The source data usually includes private data. The private data includes, for example, a diagnosis and treatment result (for example, detailed information of an illness with which the user is diagnosed) of a user, deposit data (for example, a specific deposit amount) of the user, and some private social data (for example, a personal address, and some private pictures) of the user. Therefore, a protection mechanism needs to be set for the data processing process to protect the private data from leakage in the processing process. A commonly used protection mechanism is a beforehand code review mechanism. Specifically, before a data processing process is performed, it is necessary to acquire all code programs used in the data processing process. The code programs include a code program for performing a preprocessing operation on source data, a code program for performing aggregation calculation, and a code program for performing another operation (for example, a request operation, and an interface operation) in the data processing process. The code programs are reviewed manually or by using a dedicated tool to determine whether the code programs are reliable. If the code programs are reliable, it is proved that the data processing process does not steal private data. In this case, it is allowed to use the code programs to perform the data processing process. However, such a beforehand code review mechanism implements limited data protection. For example, when microcodes (a type of non-open source code) are used for some codes in the code programs, it is very difficult to determine in a review process whether there is a backdoor program in these code programs, and it is also very difficult to predict whether an abnormal operation occurs in an actual execution process of these code programs. In this case, potential security hazards may be left in a data processing process. In addition, these code programs also need to be protected and cannot be completely open for review in an actual application. Further, it is impossible to protect the security of a data processing process.

To improve the security of a data processing process, embodiments of the present disclosure provide a data processing solution. The solution mainly includes several technical improvements as follows: (1) A beforehand code review operation is no longer performed before the data processing process is performed. Instead, the data processing process is directly performed. The data processing process includes two subprocesses, that is, a preprocessing process and an aggregation calculation process. The two subprocesses are separately performed. However, a secure audit process is introduced between the two subprocesses. (2) The preprocessing process is performed by a data node, and is used for performing a preprocessing operation on source data to obtain target data. It needs to be ensured that the preprocessing operation is performed according to a processing rule that is jointly recognized by an owner (for example, the data node) of the source data and a processing node before it can be ensured that the target data can be used by the aggregation calculation process, and in addition, private data in the source data is protected from leakage. (3) The concept of an operation ledger is provided.

The operation ledger is used for recording operation information of a preprocessing operation. The operation ledger herein is a vector ledger. Differences between the vector ledger and a conventional distributed ledger are as follows: First, both the distributed ledger and the vector ledger are used for recording factual data. However, the factual data recorded in the distributed ledger is single data. The vector ledger records a data flow that is mutually verified based on a plurality of sides (sides involved in an operation, for example, a business demander, a data owner, and a data processor), for example, operation information (or an operation flow) recorded in the operation ledger. The operation information includes operation content of operators (a physical device on a source data side, an interface device, and a physical device on a target data side) that is sequentially recorded according to a time order in which data is operated. If any side tampers the data, it may be impossible for the operation flow in the vector ledger to remain continuous, thereby ensuring that the vector ledger is tamper-proof.

Although a conventional distributed ledger is also tamper-proof, this feature is ensured by a large number of nodes by backing up the same factual data. The feature that the vector ledger is tamper-proof is ensured based on the relevance of operation information between a plurality of operators. That is, nodes involved in the vector ledger are associated with each other based on the relevance of operation information, and the nodes may verify each other without the need of backup by large number of nodes, thereby reducing costs to some extent. In addition, the vector ledger has a variety of deployment forms. For example, in an initial stage of forming the vector ledger, there may be a form that the vector ledger and the distributed ledger are interconnected, and reference facts and reference time in the vector ledger may be based on exiting timestamp nodes. When an increasingly large number of data flows that can verify each other are recorded by using the vector ledger, driven by cost reduction, the vector ledger keeps expanding to cover a wide variety of industries. Within a particular time range, because the vector ledger is verified based on the causality of timing, when false data is recorded in the vector ledger, the false data may be discovered and marked. For example, the vector ledger may be combined with big data processing and artificial intelligence inference. A method such as a big data processing method or an artificial intelligence processing method is used to mark false data in a data flow recorded in the vector ledger.

Thus, through the combination of a vector ledger and big data processing and artificial intelligence inference, the feature that the vector ledger is tamper-proof is further enhanced. Further, the technical improvements of the solution also include: (4) In a newly added secure audit process, a solution of performing trustworthy audit based on an operation ledger is provided. Every operation stage of a preprocessing operation recorded in a vector ledger may be traced according to operation information of the preprocessing operation, and these operation stages are audited. When it is discovered that the operation ledger records the occurrence of an operation that violates an audit rule, it may be determined that the preprocessing operation is an invalid operation, and target data obtained from the preprocessing operation is intercepted, to prohibit the target data from participating in an aggregation calculation process. The secure audit process effectively joins the preprocessing process and the aggregation calculation process. The secure audit process can ensure that the preprocessing operation is performed according to a processing rule that is jointly recognized by an owner (for example, a data node) of source data and the processing node, to ensure that the target data can be used in the aggregation calculation process. In addition, private data in the source data is protected from leakage. It can also be ensured that all target data that participates in the aggregation calculation process is reliable data, to ensure the security of the aggregation calculation process, thereby improving the overall security of the data processing process. (5) The audit rule used in the secure audit process can be published and enforced in the manner of a trustworthy smart contract. In this way, the efficiency and intelligence of the secure audit process can be improved. (6) The data node, the processing node, and the business node used in the data processing process may all be node devices in the blockchain network. Transactions are conducted in the form of a transaction ledger in the data processing process. A hierarchical relationship between transaction ledgers and the association between a transaction ledger and an operation ledger are provided, thereby ensuring the high credibility of the data processing process.

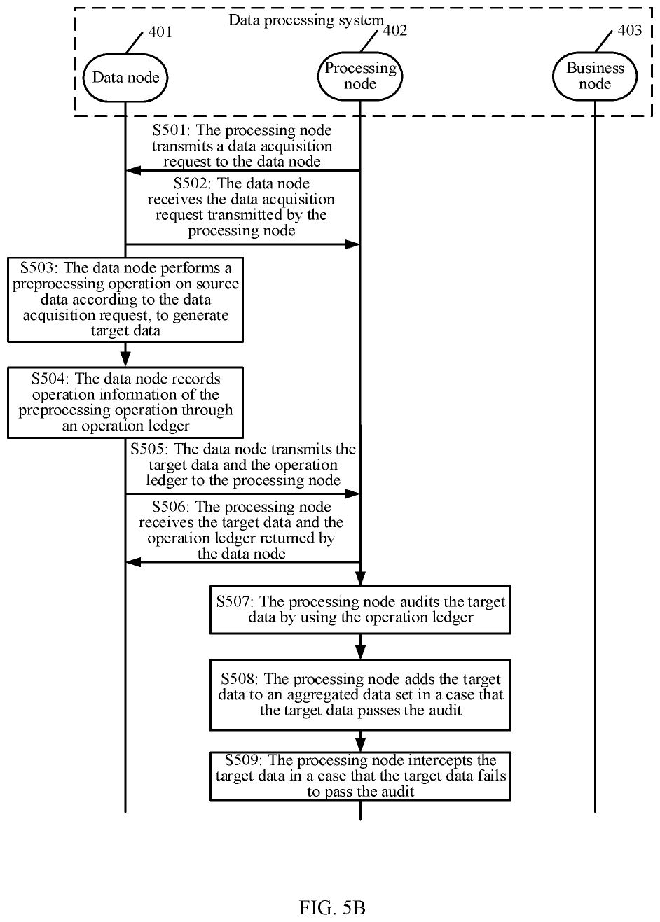

FIG. 5A is a schematic flowchart of a data processing method according to an embodiment of the present disclosure. The method may be performed by the processing node 402 shown in FIG. 4. The method may include the followings.

S410: Transmit a data acquisition request to a data node, the data node performing a preprocessing operation on source data according to the data acquisition request, generating target data, and recording operation information of the preprocessing operation in an operation ledger.

S420: Receive the target data and the operation ledger returned by the data node.

S430: Audit the target data by using the operation ledger, to determine whether the preprocessing operation recorded in the operation ledger is a valid operation.

S440: Add the target data to an aggregated data set when the target data passes the audit, the aggregated data set including a plurality of pieces of data that pass the audit, the plurality of pieces of data that pass the audit being provided to a business node, so that the business node provides a business service to a user.

The data processing method provided in this embodiment of the present disclosure is described below with reference to FIG. 5B.

FIG. 5B is a flowchart of a data processing method according to certain embodiments of the present disclosure. The method may be implemented through interaction between the data node 401 and the processing node 402 shown in FIG. 4. The method may include the following S501 to S509.

S501: The processing node transmits a data acquisition request to the data node.

S502: The data node receives the data acquisition request transmitted by the processing node.

The data acquisition request transmitted by the processing node is used for triggering the data node to perform a preprocessing operation on the source data.

S503: The data node performs a preprocessing operation on source data according to the data acquisition request, to generate target data.

The preprocessing operation may include at least one of the following: a format conversion operation and a masking operation. The format conversion operation is used for converting a format of the source data according to a format requirement of aggregation calculation. An objective of the format conversion operation is to convert source data that does not satisfy or does not completely satisfy the format requirement of the aggregation calculation into target data that completely satisfies the format requirement of the aggregation calculation and is suitable for the aggregation calculation. For example, historical diagnosis and treatment data of medical institutions is stored according to respective format policies of the medical institutions. Formats of the historical diagnosis and treatment data do not necessarily satisfy the format requirement of the aggregation calculation. For example, the source data (that is, the originally stored historical diagnosis and treatment data) is description text in a natural language format. In this case, the description text needs to be converted into digital text in a binary format to perform the aggregation calculation. The masking operation is used for masking private data in the source data. The private data is data that an owner of the source data cannot or does not intend to disclose. For example, according to requirements of laws and regulations, a medical institution is not allowed to disclose some private information (for example, a diagnosis and treatment result of a patient user) of a patient. Alternatively, based on an operation requirement of a medical institution, the medical institution does not intend to disclose some private information (for example, a diagnosis and treatment charge of a patient user) of a patient. In this case, a masking operation needs to be performed on such private data that the owner cannot or does not intend to disclose. An objective of the masking operation is to protect the private data in the source data from leakage without affecting the aggregation calculation. The preprocessing operation is not limited to the format conversion operation and/or the masking operation, and may further include another operation such as a tokenization processing operation.

S504: The data node records operation information of the preprocessing operation through an operation ledger.

S505: The data node returns the target data and the operation ledger to the processing node.

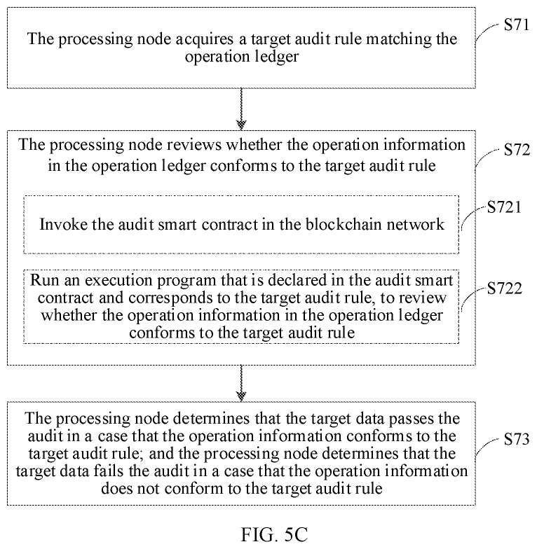

The operation ledger is a vector ledger. FIG. 6 is a schematic diagram of storage of an operation ledger according to certain embodiments of the present disclosure. As shown in FIG. 6, the operation information recorded in the operation ledger includes an operation code and an operation parameter, the operation code including at least one of the following: an operation instruction and an operation function, the operation parameter including source data, an address of the source data, an address of target data, the target data, and a data change caused by an operation. The operation information further includes an operation flow when the address of the source data points to a source physical device (including devices such as a PC, a PDA, a mobile phone, a smart wearable device, and a server), the address of the target data points to a target physical device (including devices such as a PC, a PDA, a mobile phone, a smart wearable device, and a server), and the source physical device and the target physical device are interconnected by an interface. The operation flow includes the following: an operation time and operation content of the source physical device, an operation time and operation content of an interface operation, and an operation time and operation content of the target physical device. The operation time herein may be represented by using a timestamp. The operation content may include the following content: an identifier of an operator, an identifier of operated data, an interface data flow (for example, an origin and a destination of between which the operated data is transmitted), and a change in data caused by an operation (for example, formats of the operated data before and after conversion, or values of the operated data before and after a change), and the like. Thus, the operation ledger is a vector ledger based on an operation time order. In some implementations, the operation information is encrypted into a receipt, and is stored in the operation ledger. The encryption herein may be implemented based on one of various encryption algorithms. The encryption algorithm may include any one of the following: a symmetric-key encryption algorithm, an asymmetric-key encryption algorithm, and a hash algorithm.

S506: The processing node receives the target data and the operation ledger returned by the data node.

S507: The processing node audits the target data by using the operation ledger, to determine whether the preprocessing operation recorded in the operation ledger is a valid operation.

The audit is performed by using the operation ledger as a basis. Because the operation ledger is a vector ledger based on an operation time order, every operation stage of a preprocessing operation recorded in the operation ledger may be traced based on operation information of the preprocessing operation. In this case, these operation stages may be audited by using a matching audit rule. In some embodiments, as shown in FIG. 5C, S507 specifically includes the following S71 to S73.

S71: The processing node acquires a target audit rule matching the operation ledger.

S72: The processing node reviews whether the operation information in the operation ledger conforms to the target audit rule.

S73: The processing node determines that the target data passes the audit when the operation information conforms to the target audit rule; and the processing node determines that the target data fails the audit when the operation information does not conform to the target audit rule.

The target audit rule matches the operation ledger, and is a rule that is formulated in advance according to an actual case and is jointly recognized by an owner (for example, the data node) of data and the processing node. The so-called matching means that the target audit rule is formulated based on an attribute (including a type, and a field) corresponding to an operation recorded in the operation ledger, and is suitable for auditing the operation recorded in the operation ledger. For example, for a preprocessing operation on historical diagnosis and treatment data of a user, an audit rule matching the preprocessing operation may be formulated according to the format requirement of the aggregation calculation, a privacy requirement of a medical institution, and health care-related laws and regulations. In another example, for a preprocessing operation on historical deposit data and historical loan data of a user, an audit rule matching the preprocessing operation may be formulated according to the format requirement of the aggregation calculation, a privacy requirement of a bank or financial institution, and finance-related laws regulations. In another example, for a preprocessing operation on historical social data of a user, an audit rule matching the preprocessing operation may be formulated according to the format requirement of the aggregation calculation, a privacy requirement of a social platform, and Internet-related laws regulations. When it is discovered that the operation ledger records the occurrence of an operation that violates an audit rule, it may be determined that the preprocessing operation is an invalid operation, to further determine that the target data fails the audit, and the target data is not suitable for participating in the aggregation calculation process. When it is discovered that all operations recorded in the operation ledger conform to the audit rule, it may be determined that the preprocessing operation is a valid operation, to further determine that the target data passes the audit, and the target data may participate in the aggregation calculation process.

In some other embodiments, the target audit rule may be published to a blockchain network in the form of an audit smart contract. In this case, as shown in FIG. 5C, S72 specifically includes the following S721 and S722.

S721: Invoke the audit smart contract in the blockchain network.

S722: Run an execution program that is declared in the audit smart contract and corresponds to the target audit rule, to review whether the operation information in the operation ledger conforms to the target audit rule.

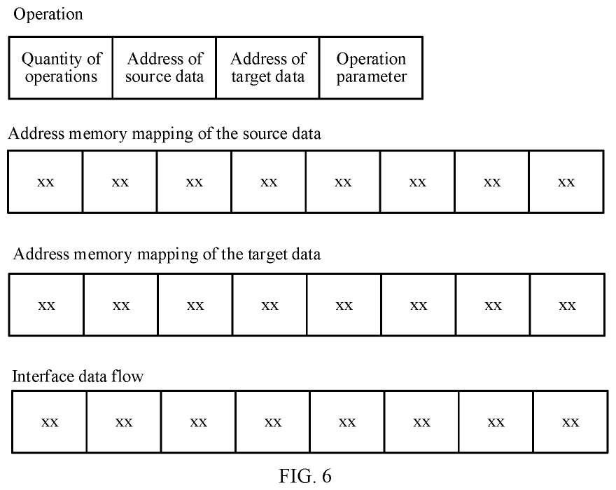

In some implementations, one audit smart contract includes only one audit rule, and one audit rule matches one operation ledger. FIG. 7A is a schematic diagram of an audit smart contract according to certain embodiments of the present disclosure. Referring to FIG. 7A, an operation ledger 1 matches an audit rule 1, the audit rule 1 corresponds to an audit smart contract 1, an operation ledger 2 matches an audit rule 2, and the audit rule 2 corresponds to an audit smart contract 2. The rest is deduced by analogy. In this case, for a plurality of operation ledgers, a plurality of audit smart contracts need to be separately invoked to perform audit.

In some other implementations, one audit smart contract may include a plurality of audit rules, and each audit rule matches one operation ledger. FIG. 7B is a schematic diagram of another audit smart contract according to certain embodiments of the present disclosure.

Referring to FIG. 7B, an operation ledger 1 matches an audit rule 1, an operation ledger 2 matches an audit rule 2, and the audit rule 1 and the audit rule 2 jointly correspond to an audit smart contract 2. The rest is deduced by analogy. In this case, for a plurality of operation ledgers, one same audit smart contract may be invoked to perform audit.

It can be understood that the audit rule is a rule that is formulated in advance according to an actual case and is jointly recognized by an owner (for example, a data node) of data and a processing node. One audit rule usually includes a plurality of detailed rules. These detailed rules may include a detailed privacy protection rule jointly recognized by the owner (for example, the data node) of data and the processing node, a detailed data quality rule jointly recognized by the owner (for example, the data node) of data and the processing node, a detailed data format rule jointly recognized by the owner (for example, the data node) of data and the processing node, and the like. In some feasible implementations, these detailed rules may be stored in the same device (for example, stored in the processing node) or may be stored in different devices in a distributed manner. In addition, during use, a plurality of detailed rules may be flexibly combined as required to obtain an audit rule. For example, the audit rule 1 includes a detailed rule 1 and a detailed rule 2. The detailed rule 1 and the detailed rule 2 are combined into the audit rule 1. The audit rule 2 includes the detailed rule 1 and a detailed rule 3. The detailed rule 1 and the detailed rule 3 are combined into the audit rule 2. In this way, the reusability of the detailed rules (for example, the foregoing detailed rule 1) can be improved.

5508: The processing node adds the target data to an aggregated data set when the target data passes the audit.

As discussed above, the target data passes the audit, representing that all operations recorded in the operation ledger conform to the audit rule, the preprocessing operation is a valid operation, and the target data may participate in the aggregation calculation process. Therefore, the target data may be added to the aggregated data set. Herein, the aggregated data set includes a plurality of pieces of data that pass the audit. That is, all data in the aggregated data set is data that passes the audit. The aggregated data set is the basis for the aggregation calculation process, and is used for providing data required for the aggregation calculation process.

In some feasible implementations, the method may further include S509: intercepting the target data when the target data fails the audit. As discussed above, when the target data fails the audit, indicating that the operation ledger records the occurrence of an operation that violates the audit rule, it is determined that the preprocessing operation is an invalid operation. When the target data is used for participating in the aggregation calculation process, there may be a security risk in the aggregation calculation process. Therefore, the target data is not suitable for participating in the aggregation calculation process, and the target data may be intercepted, to prohibit the target data from being added to the aggregated data set, thereby prohibiting the target data from participating in the aggregation calculation process.

In an embodiment, the processing node may be an independent device or may be a combination of a plurality of devices. Specifically, when one device has a data storage capability, an audit capability, an aggregation calculation capability, and the like at the same time, the device may be independently used as the processing node. The target data and the operation ledger transmitted by the data node may be transmitted together to the device. The device independently performs a storage process, an audit process, and an aggregation calculation process on the target data. Certainly, it may be understood that when one device has a data storage capability, another device has an aggregation calculation capability, and still another device has an audit capability, a combination of the three devices may be used as one processing node 402. In this case, the target data returned by the data node to the processing node 402 is transmitted to the device having the data storage capability, the operation ledger returned by the data node to the processing node 402 is transmitted to the device having the audit capability, and the aggregation calculation process is performed by the device having the aggregation calculation capability. The three devices coordinate to complete a data processing procedure.

In the embodiments of the present disclosure, target data provided by a data node is securely and credibly audited by using an operation ledger. In this way, it can be ensured that a preprocessing operation is performed according to a processing rule that is jointly recognized by an owner (for example, a data node) of source data and a processing node, to ensure that the target data can be used in an aggregation calculation process. In addition, private data in the source data is prevented from leakage. In addition, it can also be ensured that all data in the aggregation calculation process is reliable data, to help ensure the security of the subsequent aggregation calculation process, thereby improving the security of an entire data processing process.

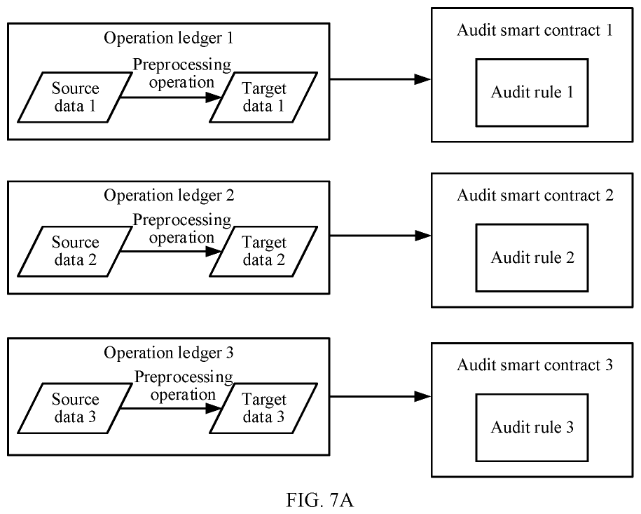

FIG. 8 is a flowchart of a data processing method according to certain embodiments of the present disclosure. The method may be implemented through interaction between the data node 401, the processing node 402, and the business node 403 shown in FIG. 4. The method may include the following S801 to S812.

S801: The business node transmits a data processing request to the processing node.

S802: The processing node receives the data processing request transmitted by the business node.

The data processing request of the business node may be initiated on a data processing transaction platform. The data processing transaction platform herein may be any platform in the following: a website, an application (APP), and some applets or subroutines connected to the APP. After a business demander (for example, an employee of an insurance company, a bank worker or an advertiser) enters a data processing transaction platform through a business node, the business demander may perform a data processing request operation (for example, clicking a data processing request button or selecting a data processing request option) on a service page in the data processing transaction platform. In this case, the business node transmits the data processing request to the processing node.

S803: The processing node transmits a data acquisition request to the data node.

S804: The data node receives the data acquisition request transmitted by the processing node.

S805: The data node performs a preprocessing operation on source data according to the data acquisition request, to generate target data.

S806: The data node records operation information of the preprocessing operation through an operation ledger.

S807: The data node returns the target data and the operation ledger to the processing node.

S808: The processing node receives the target data and the operation ledger returned by the data node.

S809: The processing node audits the target data by using the operation ledger.

S810: The processing node adds the target data to an aggregated data set when the target data passes the audit. The aggregated data set includes a plurality of pieces of data that pass the audit.

S811: The processing node performs aggregation calculation on the plurality of pieces of data in the aggregated data set, to obtain response data.

The aggregation calculation may be implemented based on an aggregation algorithm. The aggregation algorithm herein may include a clustering algorithm, a merge algorithm, a maximum-minimum calculation algorithm, an average value calculation method, and the like. This is not limited in the embodiments of the present disclosure. The response data is a result of aggregation calculation. A type of the response data is determined according to an actual requirement of a business node. For example, in an insurance purchasing scenario, the response data is basic insurance data of a user. In a bank loan scenario, the response data is loan qualification evaluation data of a user. In an advertisement delivery scenario, the response data is interest data of a user.

S812: The processing node transmits the response data to the business node.

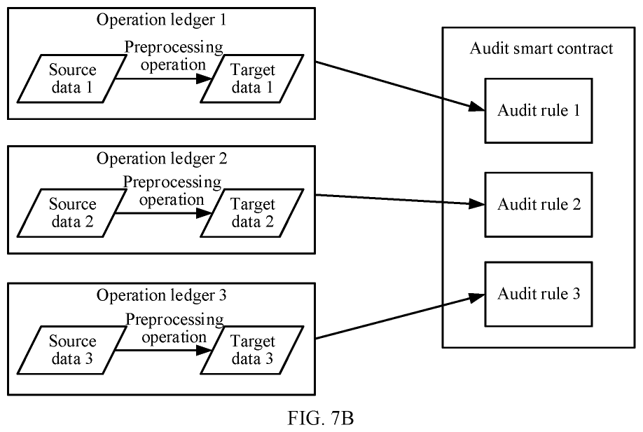

FIG. 9 is a schematic diagram of data flow directions of a data processing method according to certain embodiments of the present disclosure. In some embodiments, nodes in a data processing process may jointly maintain one same operation ledger. Specifically, the operation ledger may be transmitted by a data node to a processing node. In this case, in addition to operation information of a preprocessing operation performed by the data node, the operation ledger may further be used for recording operation information of another operation performed by the processing node. For example, the operation ledger may further be used for recording operation information of a secure audit operation performed by the processing node. In this way, the validity of the secure audit process can further be verified by using the operation ledger. In another example, the operation ledger may further record operation information of an aggregation calculation operation performed by the processing node. In this way, the validity of the aggregation calculation operation can be traced and verified by using the operation ledger. For example, data used in the aggregation calculation operation is verified, or an algorithm or a calculation model used in aggregation calculation is verified. The operation ledger may further be transmitted by the processing node to a business node. In this way, the operation ledger may further be used for recording operation information of the business node. That is, the operation ledger may perform interaction between the nodes (the business node, the data node, and the processing node) used in the data processing process, and is used for recording operation information of operations separately performed by the nodes in the data processing process. In this way, all operations used in the data processing process may be traced and verified by using the operation ledger.

In addition, the same operation ledger maintained by the nodes is a vector ledger. The vector ledger may use a vectorized block to store the operation information of the nodes. For example, the operation ledger includes a vectorized block 1, a vectorized block 2, a vectorized block 3, and a vectorized block 4. The vectorized block 1 is used for storing operation information (including an operation time, an operation data flow, and the like) of the preprocessing operation performed by the data node. The vectorized block 2 is used for storing operation information of a security calculation operation performed by the processing node. The vectorized block 3 is used for storing operation information of the aggregation calculation operation performed by the processing node. The vectorized block 4 is used for storing operation information of an operation performed by the business node. The vectorized blocks are associated according to the operation time recorded in the vectorized blocks and have connectivity. As can be seen, the vector ledger is a set of vectorized blocks, that is, a ledger data set formed by continuous operation data flows that can verify each other of the plurality of nodes.

In some other embodiments, the nodes in the data processing process may maintain respective operation ledgers. However, the operation ledgers of the nodes are associated with each other. Specifically, the data node may maintain one operation ledger. The operation ledger is used for recording the operation information of the preprocessing operation performed by the data node. The processing node may also maintain one operation ledger. The operation ledger is used for recording the operation information of the secure audit operation and the operation information of the aggregation calculation operation that are performed by the processing node. The business node may also maintain one operation ledger. The operation ledger may be used for recording a series of subsequent processing (for example, the processing of transmitting the response data to another device) on the response data by the business node. The operation ledgers of the nodes provide service to the same data processing process. Therefore, these operation ledgers are associated with each other. In this case, an association relationship among the operation ledgers of the nodes is also one vector ledger. The operation ledgers of the nodes may verify the validity of all operations in the data processing process, and the operation ledgers of the nodes may also verify each other.

One transaction usually starts with one request and ends with one response. In short, one transaction may be formed by one request and one response. In this embodiment, an objective of transmitting the data processing request by the business node is to obtain the response data. In this case, the data processing request and the response data form one transaction. The data processing request and the response data may both be recorded in a secondary transaction ledger. Similarly, an objective of transmitting the data acquisition request to the data node by the processing node is to obtain the target data. In this case, the data acquisition request and the target data form one transaction. The data acquisition request and the target data may both be recorded in a primary transaction ledger. The primary transaction ledger and the secondary transaction ledger are used for reflecting a hierarchical relationship between the transaction ledgers. The hierarchical relationship uses the aggregation calculation process as a reference basis. The primary transaction ledger is used for recording an upstream transaction of the aggregation calculation process. The secondary transaction ledger is used for recording a downstream transaction of the aggregation calculation process. Specifically, the transaction formed by the data processing request and the response data is completed after the aggregation calculation process is ended, and the transaction is a downstream transaction of the aggregation calculation process. Therefore, the transaction is recorded in the secondary transaction ledger. The transaction formed by the data acquisition request and the target data is completed before the aggregation calculation process is started, and the transaction is an upstream transaction of the aggregation calculation process. Therefore, the transaction is recorded in the primary transaction ledger.

In some implementations, a transaction may be conducted in the form of a ledger. As shown in FIG. 9, specifically, the data acquisition request transmitted by the processing node is transmitted to the data node through the primary transaction ledger. That is, the processing node transmits the primary transaction ledger (the data acquisition request is recorded in the primary transaction ledger) to the data node. The target data is returned by the data node to the processing node through the primary transaction ledger. That is, the data node transmits the primary transaction ledger to the processing node (both the data acquisition request and the target data are recorded in the primary transaction ledger). The processing node uses the primary transaction ledger transmitted by the data node to update the primary transaction ledger that is locally stored in the processing node. That is, after the transaction is completed, content recorded in the primary transaction ledger on the side of the data node is consistent with content recorded in the primary transaction ledger on the side of the processing node. Similarly, the data processing request is transmitted by the business node to the processing node through the secondary transaction ledger. That is, the business node transmits the secondary transaction ledger (the data processing request is recorded in the secondary transaction ledger) to the processing node. The response data is transmitted by the processing node to the business node through the secondary transaction ledger. That is, the processing node transmits the secondary transaction ledger (both the data processing request and the response data are recorded in the secondary transaction ledger) to the business node. The business node uses the secondary transaction ledger transmitted by the processing node to update the secondary transaction ledger that is locally stored in the business node. That is, after the transaction is completed, content recorded in the secondary transaction ledger on the side of the business node is consistent with content recorded in the secondary transaction ledger on the side of the processing node.

It can be understood that the primary transaction ledger and the secondary transaction ledger are associated with each other. Specifically, the data acquisition request in the primary transaction ledger is triggered by the data processing request in the secondary transaction ledger. The response data in the secondary transaction ledger is obtained through aggregation calculation of the target data in the primary transaction ledger. Further, the primary transaction ledger and the secondary transaction ledger are both associated with the operation ledger. Specifically, the data processing request in the secondary transaction ledger triggers to generate the target data in the operation ledger and the primary transaction ledger. The operation ledger may further be used as the basis for auditing the target data in the primary transaction ledger. Further, an audit process performed based on the operation ledger further affects a result of the response data in the secondary transaction ledger. That is, the ledgers used in the data processing process in the embodiments of the present disclosure have both a hierarchical relationship and an association relationship. On a macro level, the hierarchical relationship or association relationship between the ledgers is also a vector ledger. In this case, the ledgers may verify each other.

In some implementations, the ledgers may verify each other. Therefore, when there is operation information missing in the operation ledger, the data recorded in the primary transaction ledger and/or the data recorded in the secondary transaction ledger may be set as reference factual data for operation information missing in the operation ledger. That is, the data recorded in the primary transaction ledger and/or the data recorded in the secondary transaction ledger is used for verifying and supplementing the operation ledger.

In some other implementations, as shown in FIG. 9, the data node may use a dedicated preprocessing computing engine to perform the preprocessing operation on the source data. The processing node may use a dedicated aggregation calculation engine to perform the aggregation calculation on a plurality of pieces of data in the aggregated data set. In FIG. 9, N is a positive integer. The preprocessing computing engine and the aggregation calculation engine may be provided by a third-party service organization. Before a data processing process is performed, the preprocessing computing engine and the aggregation calculation engine need to register with the processing node in advance. In the registration process herein, a to-be-registered engine needs to provide an identifier of the to-be-registered engine. The identifier herein may include a user registration interface (URI) of the to-be-registered engine, an identity of the to-be-registered engine or another identifier that may be addressed to the engine. The preprocessing computing engine needs to be successfully registered before the preprocessing computing engine can be configured to perform the preprocessing operation. Similarly, the aggregation calculation engine needs to be successfully registered before the aggregation calculation engine can be configured to perform the aggregation calculation operation. A registration mechanism can ensure that only a computing engine that is successfully registered can participate in the data processing process, thereby further ensuring the security of the data processing process.

In some other implementations, the data node, the business node, and the processing node may all be node devices (the node devices shown in FIG. 3) in a blockchain network. The blockchain network herein includes any one of the following: a private blockchain network, a consortium blockchain network, and a public blockchain network. This is equivalent to that the data processing process in the embodiments of the present disclosure is performed based on the blockchain network. It can be understood that the data processing process may be completely performed in the blockchain network. For example, a preprocessing operation of the data node, a generation process of an operation ledger, a secure audit process, an aggregation calculation process, and a transaction conducted through a transaction ledger, and the like may all be performed in the blockchain network. In this way, with the fairness and publicness of a blockchain, a full process of data processing is more trustworthy, thereby further improving the security of the data processing process. Certainly, the data processing process in this embodiment may be partially performed in the blockchain network. For example, the preprocessing operation of the data node and the generation process of an operation ledger may be performed off the blockchain. The secure audit process may be performed in the blockchain network. The aggregation calculation process may be performed off the blockchain. A transaction conducted through the transaction ledger may be performed in the blockchain network. In this way, the expandability of operations off the blockchain may be utilized, and the fairness and openness of the blockchain can be utilized, so that the data processing process is more flexible, and the security of the data processing process is also ensured.

Accordingly, in the embodiments of the present disclosure, first, a data processing request of a business node triggers a data node to perform a preprocessing operation on source data to obtain target data and an operation ledger. The target data provided by the data node is securely and credibly audited by using the operation ledger. In this way, it can be ensured that the preprocessing operation is performed according to a processing rule that is jointly recognized by an owner (for example, the data node) of the source data and a processing node, to ensure that the target data can be used in an aggregation calculation process. In addition, private data in the source data is prevented from leakage. Next, target data that passes the audit is added to an aggregated data set, and aggregation calculation is performed on a plurality of pieces of data that pass the audit in the aggregated data set to obtain response data, and the response data is returned to the business node. In this way, it is ensured that all data in the aggregation calculation process is reliable data, to ensure the security of the aggregation calculation process, thereby improving the security of an entire data processing process. Next, a transaction is conducted in the form of a ledger in the data processing process. A plurality of ledgers have a hierarchical relationship and an association relationship. The plurality of ledgers may verify each other to jointly maintain the reliability of the data processing process. The data processing process may further be implemented based on a blockchain network, thereby further improving the security of the data processing process.

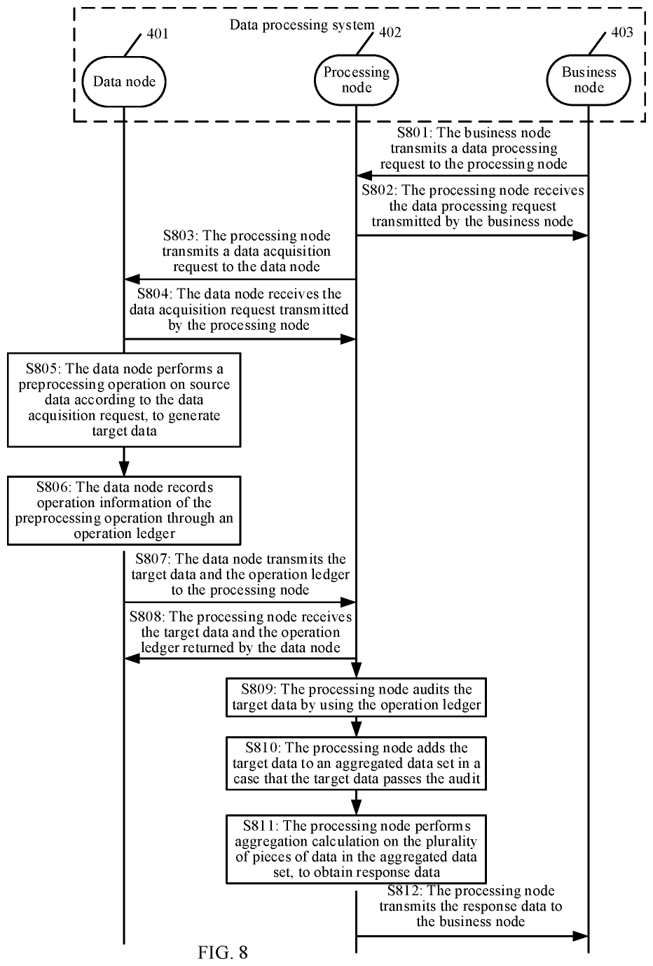

FIG. 10 is a schematic structural diagram of a data processing apparatus according to certain embodiments of the present disclosure. The data processing apparatus may be a computer program (including program code) run in the processing node 402, for example, may be application software in the processing node 402. The data processing apparatus may be configured to perform corresponding steps in the methods in FIG. 5A to FIG. 5C or FIG. 8. Referring to FIG. 10, the data processing apparatus includes a request transmit unit 1001, a ledger receiving unit 1002, an audit unit 1003, and a processing unit 1004, etc.

The request transmit unit 1001 is configured to transmit a data acquisition request to a data node, the data node performing a preprocessing operation on source data according to the data acquisition request, generating target data, and recording operation information of the preprocessing operation in an operation ledger; the ledger receiving unit 1002 is configured to receive the target data and the operation ledger returned by the data node; the audit unit 1003 is configured to audit the target data by using the operation ledger, to determine whether the preprocessing operation recorded in the operation ledger is a valid operation; and the processing unit 1004 is configured to add the target data to an aggregated data set when the target data passes the audit, the aggregated data set including a plurality of pieces of data that pass the audit, the plurality of pieces of data that pass the audit being provided to a business node, so that the business node provides a business service to a user.

In some implementations, the processing unit 1004 is further configured to intercept the target data when the target data fails the audit.

In some other implementations, the operation ledger is a vector ledger based on an operation time order, and operation information of a plurality of data operators is sequentially recorded in the vector ledger according to the operation time order; the operation information includes an operation code and an operation parameter, the operation code including at least one of the followings: an operation instruction and an operation function, the operation parameter including source data, an address of the source data, an address of target data, the target data, and a data change caused by an operation; and the operation information is encrypted into a receipt, and is stored in the operation ledger.

In some other implementations, the operation information further includes an operation flow when the address of the source data points to a source physical device, the address of the target data points to a target physical device, and the source physical device and the target physical device are interconnected by an interface; and the operation flow includes the following: an operation time and operation content of the source physical device, an operation time and operation content of an interface operation, and an operation time and operation content of the target physical device.

In some other implementations, the audit unit 1003 is specifically configured to: acquire a target audit rule matching the operation ledger; review whether the operation information in the operation ledger conforms to the target audit rule; and determine that the target data passes the audit when the operation information conforms to the target audit rule; and determine that the target data fails the audit when the operation information does not conform to the target audit rule.

In some other implementations, the processing node, the data node, and the business node are all node devices in a blockchain network, and the target audit rule is published in the blockchain network in the form of an audit smart contract; and the audit unit 1003 is specifically configured to: invoke the audit smart contract in the blockchain network; and run an execution program that is declared in the audit smart contract and corresponds to the target audit rule, to review whether the operation information in the operation ledger conforms to the target audit rule.

In some other implementations, the data acquisition request is recorded in a primary transaction ledger, and the data acquisition request is transmitted to the data node through the primary transaction ledger; the target data is recorded in the primary transaction ledger, and the target data is returned by the data node through the primary transaction ledger; and the primary transaction ledger is associated with the operation ledger.

In some other implementations, the aggregated data set includes a plurality of pieces of data that pass the audit; and the processing unit 1004 is further configured to: perform aggregation calculation on a plurality of pieces of data in the aggregated data set, to obtain response data; and transmit the response data to the business node.

In some other implementations, the ledger receiving unit 1002 is further configured to receive a data processing request transmitted by the business node; and the request transmission unit 1001 is further configured to transmit the data acquisition request to at least one data node according to the data processing request transmitted by the business node.

In some other implementations, the data processing request is recorded in a secondary transaction ledger, and the data processing request is transmitted by the business node through the secondary transaction ledger; the response data is recorded in the secondary transaction ledger, and the response data is transmitted to the business node through the secondary transaction ledger; and the secondary transaction ledger is associated with the operation ledger.

In some other implementations, the processing unit 1004 is further configured to: set, when there is operation information missing in the operation ledger, data recorded in the primary transaction ledger as reference fact data for the operation information missing in the operation ledger.

In some other implementations, the processing unit 1004 is further configured to: set, when there is operation information missing in the operation ledger, data recorded in the secondary transaction ledger as reference fact data for the operation information missing in the operation ledger.

In some other implementations, the data node and the business node are both node devices in a blockchain network, and the blockchain network herein includes any one of the following: a private blockchain network, a consortium blockchain network, and a public blockchain network.

According to some embodiments of the present disclosure, units of the system for data processing apparatus shown in FIG. 10 may be separately or wholly combined into one or several other units, or one (or more) of the units herein may further be divided into multiple units of smaller functions. In this way, same operations can be implemented, and implementation of the technical effects of the embodiments of the present disclosure is not affected. The foregoing units are divided based on logical functions. In an actual application, a function of one unit may also be implemented by a plurality of units, or functions of a plurality of units are implemented by one unit. In other embodiments of the present disclosure, the data processing apparatus may also include other units. During actual application, the functions may also be cooperatively implemented by other units and may be cooperatively implemented by a plurality of units. According to some other embodiments of the present disclosure, a computer program (including program code) that can perform the steps in the corresponding method shown in FIG. 5A to FIG. 5C and FIG. 8 may be run on a general computing device, such as a computer, which includes processing elements and storage elements such as a central processing unit (CPU), a random access memory (RAM), and a read-only memory (ROM), to construct the data processing apparatus shown in FIG. 10 and implement the blockchain-based data processing method in the embodiments of the present disclosure. The computer program may be recorded in, for example, a computer readable recording medium, and may be loaded into the foregoing computing device by using the computer readable recording medium, and run on the computing device.

Accordingly, in the embodiments of the present disclosure, first, a data processing request of a business node triggers a data node to perform a preprocessing operation on source data to obtain target data and an operation ledger. The target data provided by the data node is securely and credibly audited by using the operation ledger. In this way, it can be ensured that the preprocessing operation is performed according to a processing rule that is jointly recognized by an owner (for example, the data node) of the source data and a processing node, to ensure that the target data can be used in an aggregation calculation process. In addition, private data in the source data is prevented from leakage. Next, target data that passes the audit is added to an aggregated data set, and aggregation calculation is performed on a plurality of pieces of data that pass the audit in the aggregated data set to obtain response data, and the response data is returned to the business node. In this way, it is ensured that all data in the aggregation calculation process is reliable data, to ensure the security of the aggregation calculation process, thereby improving the security of an entire data processing process. Next, a transaction is conducted in the form of a ledger in the data processing process. A plurality of ledgers have a hierarchical relationship and an association relationship. The plurality of ledgers may verify each other to jointly maintain the reliability of the data processing process. The data processing process may further be implemented based on a blockchain network, thereby further improving the security of the data processing process.

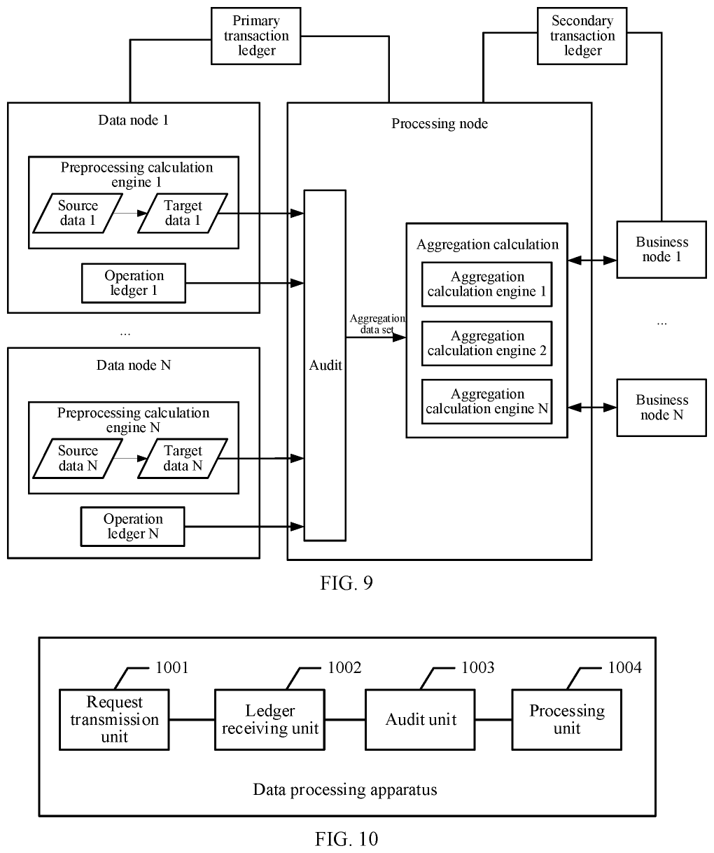

FIG. 11 is a schematic structural diagram of another data processing apparatus according to certain embodiments of the present disclosure. The data processing apparatus may be a computer program (including program code) run in the data node 401, for example, may be application software in the data node 401. The data processing apparatus may be configured to perform corresponding steps in the methods in FIG. 5A to FIG. 5C or FIG. 8. Referring to FIG. 11, the data processing apparatus includes a request receiving unit 1101, a preprocessing operation unit 1102, a recording unit 1103, and a ledger transmission unit 1104, etc.

The request receiving unit 1101 is configured to receive a data acquisition request transmitted by a processing node; the preprocessing operation unit 1102 is configured to perform a preprocessing operation on source data according to the data acquisition request, to generate target data; the recording unit 1103 is configured to record operation information of the preprocessing operation through an operation ledger.

The ledger transmission unit 1104 is configured to return the target data and the operation ledger to the processing node, to enable the processing node to audit the target data by using the operation ledger, to determine whether the preprocessing operation recorded in the operation ledger is a valid operation, and add the target data to an aggregated data set when the target data passes the audit, the aggregated data set including a plurality of pieces of data that pass the audit, the plurality of pieces of data that pass the audit being provided to a business node, so that the business node provides a business service to a user.

In some implementations, the preprocessing operation may include at least one of the followings: a format conversion operation and a masking operation; the format conversion operation is used for converting a format of the source data according to a format requirement of aggregation calculation; and the masking operation is used for masking private data in the source data.

According to some embodiments of the present disclosure, units of the system for data processing apparatus shown in FIG. 11 may be separately or wholly combined into one or several other units, or one (or more) of the units herein may further be divided into multiple units of smaller functions. In this way, same operations can be implemented, and implementation of the technical effects of the embodiments of the present disclosure is not affected. The foregoing units are divided based on logical functions. In an actual application, a function of one unit may also be implemented by a plurality of units, or functions of a plurality of units are implemented by one unit. In other embodiments of the present disclosure, the data processing apparatus may also include other units. During actual application, the functions may also be cooperatively implemented by other units and may be cooperatively implemented by a plurality of units. According to some other embodiments of the present disclosure, a computer program (including program code) that can perform the steps in the corresponding method shown in FIG. 5A to FIG. 5C and FIG. 8 may be run on a general computing device, such as a computer, which includes processing elements and storage elements such as a CPU, a RAM, and a ROM, to construct the data processing apparatus shown in FIG. 11 and implement the blockchain-based data processing method in the embodiments of the present disclosure. The computer program may be recorded in, for example, a computer readable recording medium, and may be loaded into the foregoing computing device by using the computer readable recording medium, and run on the computing device.

Accordingly, in the embodiments of the present disclosure, target data provided by a data node is securely and credibly audited by using an operation ledger. In this way, it can be ensured that a preprocessing operation is performed according to a processing rule that is jointly recognized by an owner (for example, a data node) of source data and a processing node, to ensure that the target data can be used in an aggregation calculation process. In addition, private data in the source data is prevented from leakage. In addition, it can also be ensured that all data in the aggregation calculation process is reliable data, to help ensure the security of the subsequent aggregation calculation process, thereby improving the security of an entire data processing process.

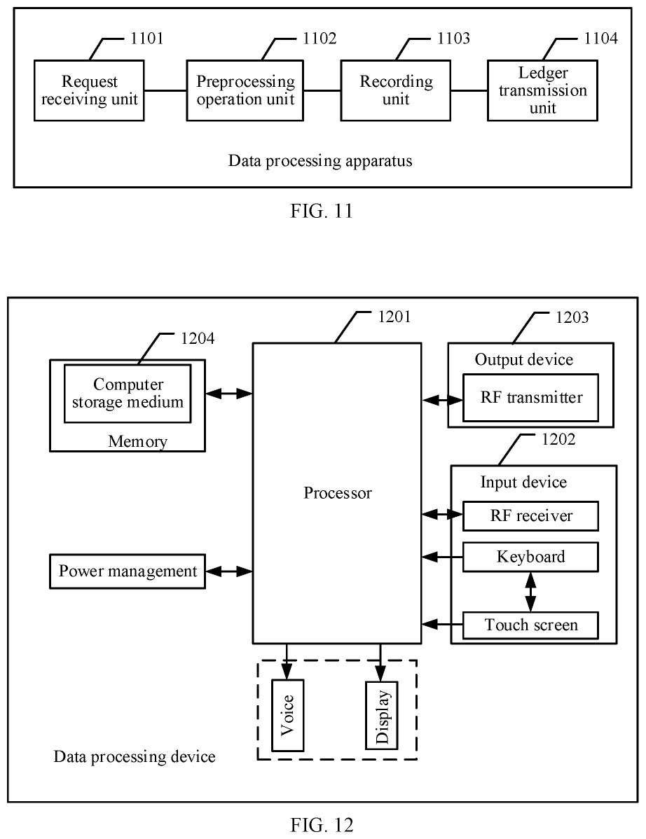

FIG. 12 is a schematic structural diagram of a data processing device according to certain embodiments of the present disclosure. Referring to FIG. 12, the data processing device at least includes a processor 1201, an input device 1202, an output device 1203, and a computer storage medium 1204. The processor 1201, the input device 1202, the output device 1203, and the computer storage medium 1204 may be connected by a bus or in another manner. The computer storage medium 1204 may be stored in a memory of the terminal. The computer storage medium 1204 is configured to store a computer program. The computer program includes program instructions. The processor 1201 is configured to execute the program instructions stored in the computer storage medium 1204. The processor 1201 (or referred to as a CPU) is a computing core and a control core of the data processing device, is suitable for implementing one or more instructions, and is specifically suitable for loading and executing one or more instructions to implement a corresponding method procedure or a corresponding function.

The embodiments of the present disclosure further provide a computer storage medium, and the computer storage medium is a memory device in a data processing device and is configured to store programs and data. It may be understood that the computer storage medium herein may include an internal storage medium of the data processing device and certainly may also include an extended storage medium supported by the data processing device. The computer storage medium provides storage space, and the storage space stores an operating system of the data processing device. In addition, the storage space further stores one or more instructions suitable for being loaded and executed by the processor 1201. The instructions may be one or more computer programs (including program code). The computer storage medium herein may be a high-speed RAM or a non-volatile memory, for example, at least one magnetic disk memory. Optionally, the computer storage medium may be at least one computer storage medium located away from the processor.

In some embodiments, the data processing device may be the processing node 402 shown in FIG. 4. The computer storage medium stores one or more first instructions. The processor 1201 may load and execute one or more first instructions stored in the computer storage medium, to implement corresponding steps of the foregoing embodiments of the data processing method. During specific implementation, the one or more first instructions in the computer storage medium are loaded by the processor 1201 to perform the followings: transmitting a data acquisition request to a data node, the data node performing a preprocessing operation on source data according to the data acquisition request, generating target data, and recording operation information of the preprocessing operation in an operation ledger; receiving the target data and the operation ledger returned by the data node; auditing the target data by using the operation ledger, to determine whether the preprocessing operation recorded in the operation ledger is a valid operation; and adding the target data to an aggregated data set when the target data passes the audit, the aggregated data set including a plurality of pieces of data that pass the audit, the plurality of pieces of data that pass the audit being provided to a business node, so that the business node provides a business service to a user.

In some implementations, the one or more first instructions in the computer storage medium are loaded and executed by the processor 1201 to further perform following: intercepting the target data when the target data fails the audit.

In some other implementations, the operation ledger is a vector ledger based on an operation time order, and operation information of a plurality of data operators is sequentially recorded in the vector ledger according to the operation time order; the operation information includes an operation code and an operation parameter, the operation code including at least one of the followings: an operation instruction and an operation function, the operation parameter including source data, an address of the source data, an address of target data, the target data, and a data change caused by an operation; and the operation information is encrypted into a receipt, and is stored in the operation ledger.

In some other implementations, the operation information further includes an operation flow when the address of the source data points to a source physical device, the address of the target data points to a target physical device, and the source physical device and the target physical device are interconnected by an interface; and the operation flow includes the following: an operation time and operation content of the source physical device, an operation time and operation content of an interface operation, and an operation time and operation content of the target physical device.

In some implementations, when the one or more first instructions in the computer storage medium are loaded by the processor 1201 and the process of auditing the target data by using the operation ledger is performed, the followings are specifically performed: acquiring a target audit rule matching the operation ledger; reviewing whether the operation information in the operation ledger conforms to the target audit rule; and determining that the target data passes the audit when the operation information conforms to the target audit rule; and determining that the target data fails the audit when the operation information does not conform to the target audit rule.

In some other implementations, the processing node, the data node, and the business node are all node devices in a blockchain network, and the target audit rule is published in the blockchain network in the form of an audit smart contract; and when the one or more first instructions in the computer storage medium are loaded by the processor 1201 and the process of reviewing whether the operation information in the operation ledger conforms to the target audit rule, the followings are specifically performed: invoking the audit smart contract in the blockchain network; and running an execution program that is declared in the audit smart contract and corresponds to the target audit rule, to review whether the operation information in the operation ledger conforms to the target audit rule.

In some other implementations, the data acquisition request is recorded in a primary transaction ledger, and the data acquisition request is transmitted to the data node through the primary transaction ledger; the target data is recorded in the primary transaction ledger, and the target data is returned by the data node through the primary transaction ledger; and the primary transaction ledger is associated with the operation ledger.

In some implementations, the aggregated data set includes a plurality of pieces of data that pass the audit; and the one or more first instructions in the computer storage medium are loaded and executed by the processor 1201 to further perform the followings: performing aggregation calculation on the plurality of pieces of data in the aggregated data set, to obtain response data; and transmitting the response data to the business node.

In some other implementations, before the one or more first instructions in the computer storage medium are loaded by the processor 1201 and the process of transmitting a data acquisition request to a data node, the following is further performed: receiving a data processing request transmitted by the business node. The transmitting a data acquisition request to a data node includes: transmitting the data acquisition request to at least one data node according to the data processing request transmitted by the business node.

In some other implementations, the data processing request is recorded in a secondary transaction ledger, and the data processing request is transmitted by the business node through the secondary transaction ledger; the response data is recorded in the secondary transaction ledger, and the response data is transmitted to the business node through the secondary transaction ledger; and the secondary transaction ledger is associated with the operation ledger.

In some other implementations, the one or more first instructions in the computer storage medium are loaded and executed by the processor 1201 to further perform the following: setting, when there is operation information missing in the operation ledger, data recorded in the primary transaction ledger as reference fact data for the operation information missing in the operation ledger.

In some other implementations, the one or more first instructions in the computer storage medium are loaded and executed by the processor 1201 to further perform the following: setting, when there is operation information missing in the operation ledger, data recorded in the secondary transaction ledger as reference fact data for the operation information missing in the operation ledger.

In still some other implementations, the data node and the business node are both node devices in a blockchain network, and the blockchain network herein includes any one of the followings: a private blockchain network, a consortium blockchain network, and a public blockchain network.

In some embodiments, the data processing device may be the data node 401 shown in FIG. 4. The computer storage medium stores one or more second instructions. The processor 1201 may load and execute one or more second instructions stored in the computer storage medium, to implement the foregoing embodiments of the data processing method. During specific implementations, the one or more second instructions in the computer storage medium are loaded by the processor 1201 to perform the followings: receiving a data acquisition request transmitted by a processing node; performing a preprocessing operation on source data according to the data acquisition request, to generate target data; recording operation information of the preprocessing operation through an operation ledger; and returning the target data and the operation ledger to the processing node, to enable the processing node to audit the target data by using the operation ledger, to determine whether the preprocessing operation recorded in the operation ledger is a valid operation, and add the target data to an aggregated data set when the target data passes the audit, the aggregated data set including a plurality of pieces of data that pass the audit, the plurality of pieces of data that pass the audit being provided to a business node, so that the business node provides a business service to a user.

In some implementations, the preprocessing operation may include at least one of the followings: a format conversion operation and a masking operation; the format conversion operation is used for converting a format of the source data according to a format requirement of aggregation calculation; and the masking operation is used for masking private data in the source data.

Accordingly, in the embodiments of the present disclosure, first, a data processing request of a business node triggers a data node to perform a preprocessing operation on source data to obtain target data and an operation ledger. The target data provided by the data node is securely and credibly audited by using the operation ledger. In this way, it can be ensured that the preprocessing operation is performed according to a processing rule that is jointly recognized by an owner (for example, the data node) of the source data and a processing node, to ensure that the target data can be used in an aggregation calculation process. In addition, private data in the source data is prevented from leakage. Next, target data that passes the audit is added to an aggregated data set, and aggregation calculation is performed on a plurality of pieces of data that pass the audit in the aggregated data set to obtain response data, and the response data is returned to the business node. In this way, it is ensured that all data in the aggregation calculation process is reliable data, to ensure the security of the aggregation calculation process, thereby improving the security of an entire data processing process. Next, a transaction is conducted in the form of a ledger in the data processing process. A plurality of ledgers have a hierarchical relationship and an association relationship. The plurality of ledgers may verify each other to jointly maintain the reliability of the data processing process. The data processing process may further be implemented based on a blockchain network, thereby further improving the security of the data processing process.

A person of ordinary skill in the art can understand that all or some of the procedures of the methods of the foregoing embodiments may be implemented by a computer program instructing relevant hardware processors. The program may be stored in a computer-readable storage medium. When the program is executed, the procedures of the foregoing method embodiments may be implemented. The foregoing storage medium may include a magnetic disc, an optical disc, a ROM, a RAM, or the like.

Further, the term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

What is disclosed above is merely some embodiments of the present disclosure, and certainly is not intended to limit the scope of the present disclosure. Therefore, equivalent variations made in accordance with the disclosed embodiments of the present disclosure shall fall within the scope of the present disclosure.

What is claimed is:

1. A data processing method for a processing node, comprising:
transmitting a data acquisition request to a data node to cause the data node performing a preprocessing operation on source data according to the data acquisition request, generating target data, and recording operation information of the preprocessing operation in an operation ledger;
receiving the target data and the operation ledger returned by the data node;
auditing the target data by using the operation ledger in an audit, to determine whether the preprocessing operation recorded in the operation ledger is a valid operation; and
adding the target data to an aggregated data set when the target data passes the audit, the aggregated data set comprising a plurality of pieces of data that pass the audit, the plurality of pieces of data that pass the audit being provided to a business node, so that the business node provides a business service to a user.

2. The method according to claim 1, further comprising:
intercepting the target data when the target data fails the audit.

3. The method according to claim 1, wherein:
the operation ledger is a vector ledger based on an operation time order, and operation information of a plurality of data operators is sequentially recorded in the vector ledger according to the operation time order;
the operation information comprises an operation code and an operation parameter, the operation code comprising at least one of: an operation instruction and an operation function, the operation parameter comprising source data, an address of the source data, an address of target data, the target data, and a data change caused by an operation; and
the operation information is encrypted into a receipt, and is stored in the operation ledger.

4. The method according to claim 3, wherein:
the operation information further comprises an operation flow when the address of the source data points to a source physical device, the address of the target data points to a target physical device, and the source physical device and the target physical device are interconnected by an interface; and
the operation flow comprises the following: an operation time and operation content of the source physical device, an operation time and operation content of an interface operation, and an operation time and operation content of the target physical device.

5. The method according to claim 1, wherein the auditing the target data by using the operation ledger comprises:
acquiring a target audit rule matching the operation ledger;
reviewing whether the operation information in the operation ledger conforms to the target audit rule; and
determining that the target data passes the audit when the operation information conforms to the target audit rule; and determining that the target data fails the audit when the operation information does not conform to the target audit rule.

6. The method according to claim 5, wherein:
the processing node, the data node, and the business node are all node devices in a blockchain network, and the target audit rule is published in the blockchain network in a form of an audit smart contract; and
the reviewing whether the operation information in the operation ledger conforms to the target audit rule comprises:
invoking the audit smart contract in the blockchain network; and
running an execution program that is declared in the audit smart contract and corresponds to the target audit rule, to review whether the operation information in the operation ledger conforms to the target audit rule.

7. The method according to claim 6, wherein the blockchain network comprises one of: a private blockchain network, a consortium blockchain network, and a public blockchain network.

8. The method according to claim 1, wherein:
the data acquisition request is recorded in a primary transaction ledger, and the data acquisition request is transmitted to the data node through the primary transaction ledger;
the target data is recorded in the primary transaction ledger, and the target data is returned by the data node through the primary transaction ledger; and
the primary transaction ledger is associated with the operation ledger.

9. The method according to claim 1, further comprising:
performing aggregation calculation on the plurality of pieces of data in the aggregated data set, to obtain response data; and
transmitting the response data to the business node.

10. The method according to claim 9, before the transmitting a data acquisition request to a data node, further comprising:
receiving a data processing request transmitted by the business node; and
the transmitting a data acquisition request to a data node comprises: transmitting the data acquisition request to at least one data node according to the data processing request transmitted by the business node.

11. The method according to claim 10, wherein:
the data processing request is recorded in a secondary transaction ledger, and the data processing request is transmitted by the business node through the secondary transaction ledger;
the response data is recorded in the secondary transaction ledger, and the response data is transmitted to the business node through the secondary transaction ledger; and
the secondary transaction ledger is associated with the operation ledger.

12. The method according to claim 11, wherein the method further comprises:
setting, when there is operation information missing in the operation ledger, data recorded in the primary transaction ledger or the secondary transaction ledger as reference fact data for the operation information missing in the operation ledger.

13. A data processing method for a data node, comprising:
receiving a data acquisition request transmitted by a processing node;
performing a preprocessing operation on source data according to the data acquisition request, to generate target data;
recording operation information of the preprocessing operation through an operation ledger; and
returning the target data and the operation ledger to the processing node, to cause the processing node to audit the target data by using the operation ledger in an audit, to determine whether the preprocessing operation recorded in the operation ledger is a valid operation, and add the target data to an aggregated data set when the target data passes the audit, the aggregated data set comprising a plurality of pieces of data that pass the audit, the plurality of pieces of data that pass the audit being provided to a business node, so that the business node provides a business service to a user.

14. The method according to claim 13, wherein:
the preprocessing operation comprises at least one of: a format conversion operation and a masking operation;
the format conversion operation is used for converting a format of the source data according to a format requirement of aggregation calculation; and
the masking operation is used for masking private data in the source data.

15. The method according to claim 13, wherein:
the operation ledger is a vector ledger based on an operation time order, and operation information of a plurality of data operators is sequentially recorded in the vector ledger according to the operation time order;
the operation information comprises an operation code and an operation parameter, the operation code comprising at least one of: an operation instruction and an operation function, the operation parameter comprising source data, an address of the source data, an address of target data, the target data, and a data change caused by an operation; and
the operation information is encrypted into a receipt, and is stored in the operation ledger.

16. The method according to claim 13, wherein the processing node acquires a target audit rule matching the operation ledger; reviews whether the operation information in the operation ledger conforms to the target audit rule; determines that the target data passes the audit when the operation information conforms to the target audit rule; and determines that the target data fails the audit when the operation information does not conform to the target audit rule.

17. A data processing system, comprising at least a processing node and a data node, wherein the processing node comprises:
a request transmit unit, configured to transmit a data acquisition request to the data node, to cause the data node performing a preprocessing operation on source data according to the data acquisition request, generating target data, and recording operation information of the preprocessing operation in an operation ledger;
a ledger receiving unit, configured to receive the target data and the operation ledger returned by the data node;
an audit unit, configured to audit the target data by using the operation ledger in an audit, to determine whether the preprocessing operation recorded in the operation ledger is a valid operation; and
a processing unit, configured to add the target data to an aggregated data set when the target data passes the audit, the aggregated data set comprising a plurality of pieces of data that pass the audit, the plurality of pieces of data that pass the audit being provided to a business node, so that the business node provides a business service to a user.

18. The data processing system according to claim 17, wherein:
the operation ledger is a vector ledger based on an operation time order, and operation information of a plurality of data operators is sequentially recorded in the vector ledger according to the operation time order;
the operation information comprises an operation code and an operation parameter, the operation code comprising at least one of: an operation instruction and an operation function, the operation parameter comprising source data, an address of the source data, an address of target data, the target data, and a data change caused by an operation; and
the operation information is encrypted into a receipt, and is stored in the operation ledger.

19. The data processing system according to claim 17, wherein the data node comprises:
a request receiving unit, configured to receive the data acquisition request transmitted by the processing node;
a preprocessing operation unit, configured to perform the preprocessing operation on source data according to the data acquisition request, to generate the target data;
a recording unit, configured to record operation information of the preprocessing operation through the operation ledger; and
a ledger transmission unit, configured to return the target data and the operation ledger to the processing node.

20. The data processing system according to claim 19, wherein:
the preprocessing operation comprises at least one of: a format conversion operation and a masking operation;
the format conversion operation is used for converting a format of the source data according to a format requirement of aggregation calculation; and
the masking operation is used for masking private data in the source data.
